(19) United States
(12) Patent Application Publication
(10) Pub. No.: US 2022/0338419 A1
(43) Pub. Date: Oct. 27, 2022

(54) Multiple robotic arm tree and shrub cutting and trimming device

(71) Applicant: Peter Richard Caruso, Irvine, CA (US)

(72) Inventor: Peter Richard Caruso, Irvine, CA (US)

(21) Appl. No.: 17/717,096

(22) Filed: Apr. 10, 2022

Related U.S. Application Data
(60) Provisional application No. 63/177,730, filed on Apr. 21, 2021.

(51) Int. Cl. A01G 3/08; B25J 13/00; B25J 11/00; B25J 5/00; A01G 3/053

(52) U.S. Cl. CPC A01G 3/08; B25J 13/006; B25J 11/0055; B25J 5/007; A01G 3/053

(57) ABSTRACT

A tree and shrub cutting and trimming device having multiple robotic arms FIG. 2B and M for gross and fine movements, a wheeled movable base FIG. 3 and an electric cutting or trimming tool. This device allows the operator to be on the ground level, a substantial distance from the cutting surface and will not be holding the cutting or trimming device FIG. 6. This device drastically reduces insurance costs and labor cost, thus a less expensive much safer device to perform these tasks is provided in this field of endeavor.

This application is by first named inventor Peter R. Caruso, citizen of the United States of America, resident of California and is continued from provisional patent with provisional patent application No. 63/177,730, confirmation number 3288 on Apr. 21, 2021.

### FEDERALLY SPONSORED RESEARCH

None

### SEQUENCE LISTING

None.

### BACKGROUND OF THE INVENTION

This invention pertains to cutting and trimming of trees, shrubs or any woody plants with multiple stems that are beyond the reach of common household cutting and trimming tools.

Prior art is as follows: using a boom lift to hold a person above the ground while holding and utilizing the cutting tool; people using ladders or climbing trees while holding the cutting equipment; a crane with a grapple saw; a pole attached to a chain saw.

The general issue with prior art is, there are only expensive or risky choices. Choices are either expensive with high insurance, high labor and high equipment costs or cheap due to the risk people take regarding bodily injury.

Specific issues with prior are is as follows; aerial or boom lift insurance may require a minimum of 2 people as a person is often required to be on the ground whenever a person is in the boom lift incase the person in the boom lift becomes incapacitated. The extent of safety concerns is demonstrated in Occupational Safety and Health Administration (OSHA) booklets which lists 2 pages of work requirements relating to this equipment under “vehicle mounted elevating and rotating work platforms”. The insurance is much higher and labor is higher due to the additional risks to the operator in using a boom lift.

Using ladders or climbing on or into the trees and shrubs to perform the cutting or trimming is also very dangerous. CDC estimates 500,000 people get treated and 300 people die each year from ladder related injuries. Furthermore cutting palm fronds is dangerous as the palm frond can suffocate the person cutting them by falling into them.

Grapple saw US20070215247A1 equipment is extremely expensive and is part of the logging industry field not trimming and cutting field. This previous art has a small overlap with this field of endeavor and will be discussed later.

A pole on a chain saw is not only vastly unergonomic and high risk to the shoulders, back and neck of the person holding it but it is dangerous as it often puts the person under the branch they are cutting. If the user stands directly under the branch it allows for cutting approximately up to 20′. If the operator steps aside and gives a greater horizontal distance from the object they are cutting, the weight and force of the chain saw at the end of the pole exerts more force on the operator's body and greatly reduces the height of the branch the user can reach. This is not used as an industry standard but only as an occasionally method most typically by a householder due to high risk of injury and short duration of use the operator can tolerate before fatigue is too great to continue.

Other than the chain saw on the pole, none of this prior art allows a high degree of visibility to the person doing the cutting or trimming towards the conditions under the object they are cutting. In all other prior art the person doing the cutting or trimming needs to be focused on the cutting or trimming tool they are holding or their view under the object they are cutting is blocked which means they are mostly or completely unaware if someone is walking under the object they are cutting making these unknowing and unsuspecting pedestrians, animals or motorists vulnerable to be hit by debris.

Advancements in technology are almost non-existent in this field of endeavor. The articulating boom lift was invented in 1951. The electric and gas powered chain saw were patented in 1926 and 1929 by Andreas Stihl. Chainsaw on a pole was patented in 1997 U.S. Pat. No. 3,513,597P. There have been improvements to these devices since they were produced but there has not been any new art other than these devices in this field of endeavor in the past 150 years.

### BRIEF SUMMARY OF THE INVENTION

The object of this invention a cheaper and safer device to trim or cut trees and shrubs beyond the reach of common house hold tools.

This device comprises of a plurality of robotic arms with varied precision affixed to each other with the largest and least precise robotic arm mounted to a wheeled movable device and with the most precise robotic arm further affixed to a cutting tool such as a chain saw or hedge trimmer.

There are several very relevant advantages to this invention. First, this invention is safer because of the distance it allows the user to be away from the cutting surface. A user may be 300 feet away from the cutting surface using most available wireless remote control systems.

Another reason it is safer is because the user can be at ground level while controlling the cutting or trimming rather than being in the tree or on a ladder or roof while holding and operating the cutting tool. There is no particular distance for the user to fall from as well as they are not holding a cutting device while they fall or land.

Another reason this device is safer than previous art is that the user does not have to hold the cutting equipment. According to the Center of Disease Control (CDC), 36000 people per year are treated at a hospital for a chainsaw injury.

This invention is cheaper and far more maneuverable than grapple crane saws which are part of the logging industry. Some smaller Grapple Saw cranes and trucks can be used for tree branch trimming but they typically do not trim very high, usually 20-30 feet while this device can easily attain heights of 60 feet high for far cheaper equipment cost.

Because the operator can be at ground level, the operator has an enormous advantage to see what is happening under the cutting surface in order to avoid an accidental casualty. Other than the saw on a pole, no other prior art has this advantage. The CDC recommends that bystanders are at a safe distance from cutting activities. This can be monitored far easier and more consistently when the person is using a remote controller on the ground level.

This device can be used to trim branches in power lines which is much safer than a person in a boom lift cutting these entangled branches.

Reduced equipment, fewer required personnel and reduced insurance cost due to its safety are all part of the reduced cost of using this device.

The towable embodiment of this device can be parked in the shoulder of a road without the same degree of temporary traffic control (TTC) that larger trucks and boom lifts with a person in it require. The towable version of this can be parked in a shoulder, the robotic arms can be positioned to make the cutting movement and then a traffic break can be performed by two people on a radio for a momentary cutting of a branch over the roadway or between power lines. This eliminates a huge cost of a full closure of a roadway done with cones and trucks as compared to several flagmen for short periods of time. This will be used by municipalities that have issues with tree branches in power lines or decaying or growing branches over roadways.

This device can be used over cliffs or bridges where branches are lower than street level which prior art cannot do.

### BRIEF DESCTIPION OF THE DRAWINGS

This invention may be best understood by reference to the following description taken in conjunction with the accompanying drawings with known robotic arms with a plurality of degrees of freedom and with various configurations and embodiments.

FIG. 1 is a side view showing a known smaller, most precise robotic arm B with multiple degrees of freedom (DOF) mounted to known electrical cutting or trimming tool A making a cutting motion through Branch B1. FIG. 1A shows a location of the cutting tool before and after it makes the cutting motion. Support area C is the area in this embodiment that the smaller known robotic arm connects to the known larger robotic arm.

FIG. 2 shows a partial view of the larger robotic arm M mounted to the smaller robotic arm at C. The smaller robotic arm is then mounted to the electric cutting or trimming tool A.

FIG. 3 shows embodiment E where the larger robotic arm is mounted to a towable trailer.

FIG. 4 shows embodiment D where the larger robotic arm is mounted to a truck bed.

FIG. 5 shows an embodiment where the larger robotic arm is mounted to a known self-propelled non-street legal vehicle.

FIG. 6 is embodiment E from FIG. 3 showing the “operator with controller” J having the opportunity to position themself in a multitude of locations H with a vastly less obstructed view then most other art, around the cutting object G.

FIGS. 7 and 8 show trees with branches in power lines.

FIG. 9 is a second possible embodiment of know smaller more precise robotic arm with different degrees of freedom including the ability to extend L and rotation K.

FIG. 10 is a partial view of known larger robotic arm prior to removing the basket.

### REFERENCE LETTERS

A Electric cutting device

B Entire smaller robotic arm

B1 Branch 1

C Base and mounting bracket of B

D Embodiment of invention with truck bed

DOF Acronym for degree of freedom

E Embodiment of invention with towable trailer

F Embodiment of invention with 4 wheeled non-street legal vehicle.

G Cutting object and approximate cutting location.

H Two dimensional representation of range of view and location

J Combination of operator and wireless remote control unit

K Support bracket of B that can rotate.

L Embodiment of B with a DOF that can extend and retract.

M Partial view of larger robotic arm

N Work platform or Basket the operator stands in.

P Operator in work platform.

### DETAILED DESCRIPTION OF THE INVENTION

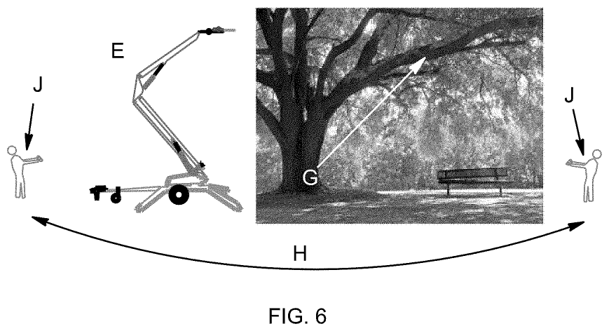

This device consists of known robotic arms with the least precise arm connected to a wheeled movable device at one end and a smaller more precise robotic arm at the other where the more precise remote controlled robotic arm is then connected to a cutting tool. This tool allows the user to be away from the cutting surface at ground level with a better view of the surrounding as shown in FIG. 6.

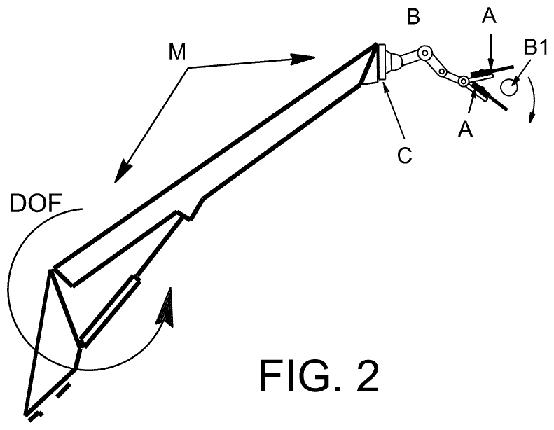

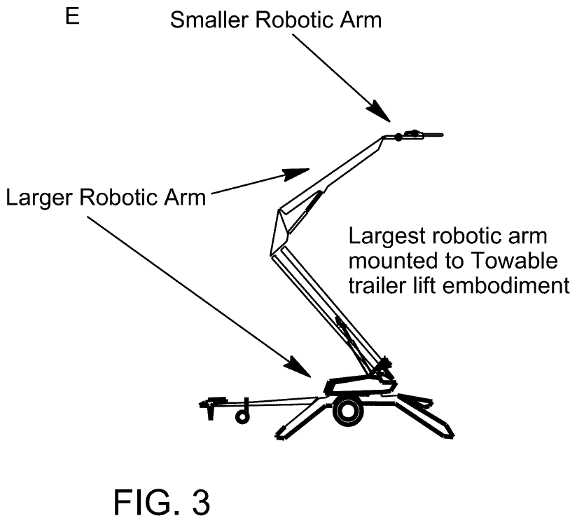

One possible embodiment is shown in partial view FIG. 2 and full view in FIG. 3.

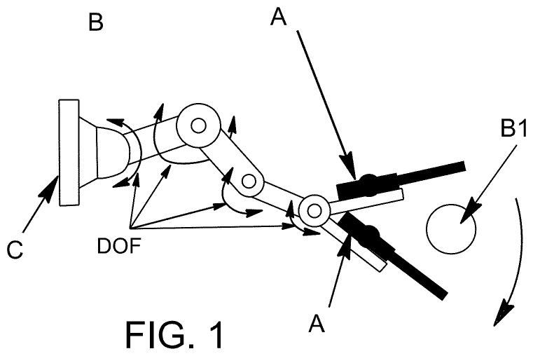

The smaller robotic arm B in FIG. 1 can have as many degrees of freedom (DOF) as necessary to get the cutting or trimming tool into the correct location to make the cutting movement needed to cut branch B1 in FIG. 1.

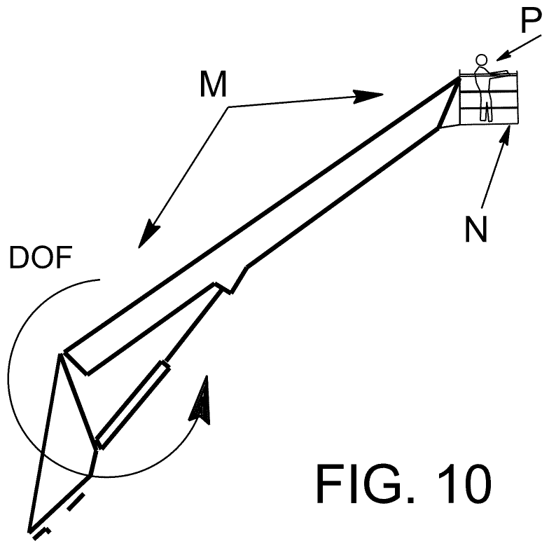

By combining a larger robotic arm to a smaller more precise robotic arm FIGS. 3-5, this device becomes a less expensive option than custom building a single robotic arm. The larger arm and wheeled device combination is currently an industry standard and is called an aerial lift or boom lift. These devices come with balancing and support systems including out-rigging and usually the large robotic arm rotates at the base. This device also comes with a work platform which is often called the “basket” FIG. 10N. The smaller arm will most like be custom designed and built with one possible embodiment depicted in FIG. 1B.

Prior art known as aerial lifts are not specific to tree trimming and seem to be much more utilized in the construction and building industry. When aerial lifts are used they are expensive as they require a larger crew and higher insurance as the worker standing on the work platform or basket, may go 40-90 feet above the ground, holds and operates the cutting device. Having a person in the work platform using a cutting tool increases insurance greatly compared to a person using a remote controller from the ground.

Most of these baskets are fastened with 5-10 bolts to the top of the robotic arm that can be easily removed. This basket is the part of the boom lift or aerial left the operator FIG. 10P, would stand in. The work platform or basket would need to be removed before connecting the smaller robotic arm using the same bolt holes. If the holes where not sufficient to connect these two parts then welding would need to be used to secure the smaller robotic arm. If a hydraulic hose was used to move the basket such as left and right and removing the basket exposes one end of the hose, then the hose would need to be used or capped.

Building one large robotic arm that is large enough and precise enough to place and move the cutting tool into the necessary location at the needed speed to perform the cutting motion with all the needed degrees of freedom would not only become too costly to manufacture but would consume too much power making it impossible to create and use with current commercially available trucks or vehicles. Currently there are no mass produced robotic arms that could perform this work that are over 15′ tall. These robotic arms have complicated power systems are very heavy and are designed to be bolted or mounted into a stationary floor.

The aerial lift cannot perform this task as it does not have enough degrees of freedom nor the horizontal and vertical placement precision needed in most situations. Most importantly it does not have the speed control to make the cutting movement successfully in any situation.

The combination of a known large mass produced robotic arm to a custom built smaller much more accurate and controllable smaller robotic arm shown in FIGS. 2-5, allows the affordability of the gross robotic arm with the needed precision and control of the fine robotic arm to perform this task.

If a mass produced robotic arm designed to be used with power tools is developed then it could be used in place of the custom smaller robotic arm.

All embodiments shown in the drawings have the same function to cut and trim but differ in the total height, cost and maneuverability.

As this device will have remote controllers to move the degree of freedoms as needed and as shown in FIG. 6J, this device allows the operator to remove themselves from close proximity to the cutting surface and attain a better view to protect themselves and pedestrians from the falling debris. If the cutting location was too far away to view or is obstructed then cameras and monitors will need to be utilized. Common camera systems for backing up recreational vehicles would likely suffice where the camera is installed near the top of the device and the monitor is supported on the wheeled base or somewhere nearby.

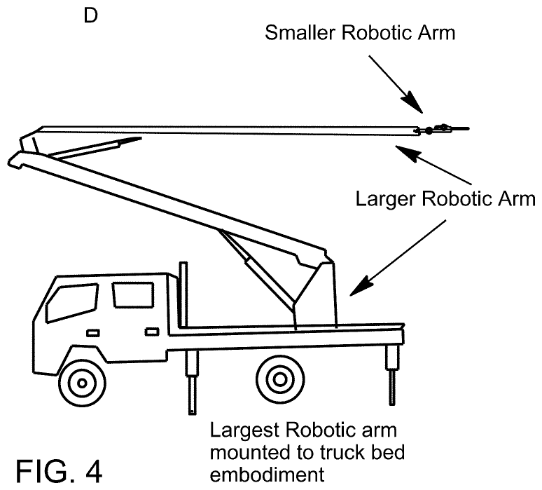

FIG. 4 shows embodiment D which is the larger robotic arm connected to a Truck bed. This is the least maneuverable, tallest and most expensive embodiment.

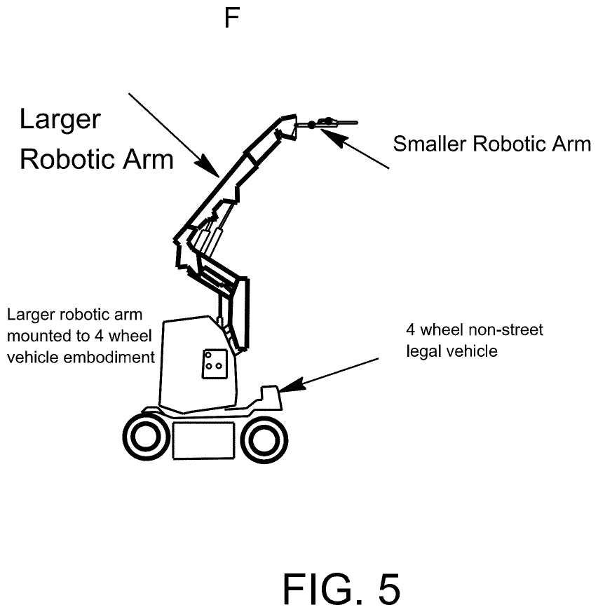

FIG. 5 shows the embodiment F where the larger robotic arm is connected to a 4 wheel non-street legal vehicle. This last embodiment has the lowest possible height but is the most maneuverable.

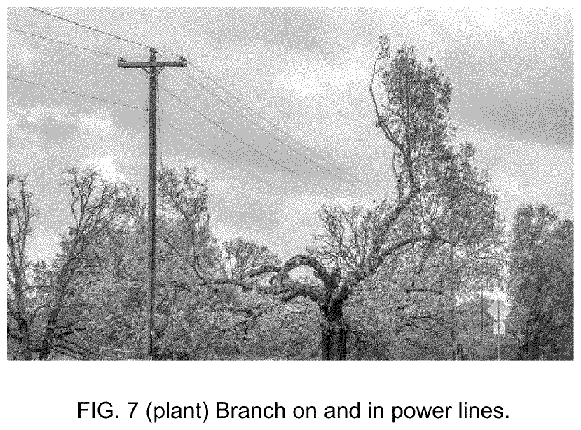

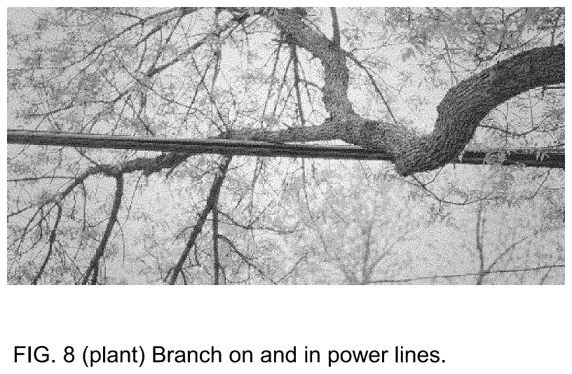

It is far safer to use this invention then all prior art in areas that require specific and or dangerous trimming such as near power-lines shown in FIG. 7 and FIG. 8.

The distance the person makes the cutting motions from is unique in this field of endeavor and puts the person in a much safer location as shown in FIG. 6. Although FIG. 6 can only show two dimensions for the range of locations in H, it would be the intention that the use does not stand under the tree branch that is being cut but rather in a position that allows for appropriate view of the cutting area, a view that allows the operator to survey the area for safety from workers or unknowing pedestrians and is a safer distance for the operator.

This invention cannot hold a tree or suspend a branch while cutting such as previous art known as a grapple saw can do. It can use various cutting instruments such as a hedge trimmer or circular saw which a grapple saw cannot. A grapple saw is listed as for the logging industry which is not the same field of endeavor but as these two inventions have a small overlap of duties they are able to perform, this should be mentioned.

The robotic arms shown in the sketches are known. Generic robotic arms are being chosen in the drawings FIGS. 1 through 6, 9 and 10 to convey its form and use as a device and are not the only options to be used. Showing sketches of all permutations and possible embodiments of either robotic arm is not possible or helpful in this patent application.

The process to make this device would involve creating a custom smaller robotic arm with the appropriate power consumptions, remote controls and degrees of freedom with an arm designed to mount the cutting tool and then mount this robotic arm to the larger robotic arm such as shown in FIG. 2M. After removing the basket from the larger robotic arm as in FIG. 10N, the larger robotic arm can be connected to FIG. 2C of the smaller arm.

All aerial lifts have power supply options for controlling the basket as well as extra power supply options built into the basket for operating hand held equipment while in the basket. Any of these options are sufficient to power the smaller robotic arm and corded cutting tools.

This device is intended to work to heights of up to or over 100′ while the most common height range is likely to be between 20′ to 60′. Mounting the cutting tool to the smaller robotic arm will likely require partial disassembly of the cutting tool to connect its structure securely to the smaller robotic arm as well as to connect the remote control.

The known cutting tool as in FIG. 1A will be electric and can be corded or battery powered but if its battery powered the cutting tool will likely be disassembled and wired to a larger battery supply and remote controllers for speed and power.

Many people have trees and shrubs on their property that they are responsible for that have grown over their homes, garages, driveways or have become tangled in power-lines FIG. 7 and FIG. 8. These are some of the areas that need a safer, cheaper way to trim and remove these dangers from their property. I have personal experience with family members having branches such ones in FIG. 6 over driveways and the minimum charge for a person in a bucket to trim several branches was $1200. Performing this same task with this device would likely be done for under $400.

Many municipalities have similar issues as mentioned in 5.23 along public use areas such as roads and parks that need similar care.

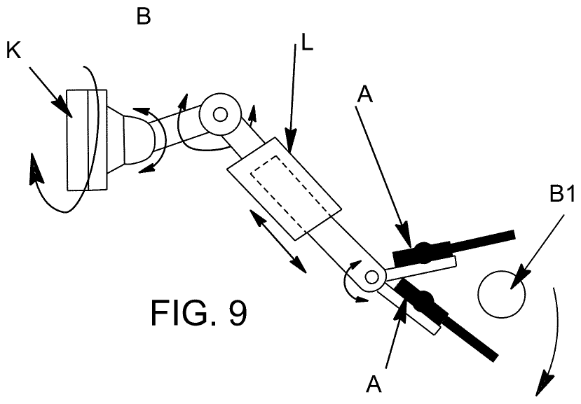

Another possible embodiment of the known smaller more precise robotic arm is shown in FIG. 9. This embodiment has rotation at the connection area to the larger robotic arm K, and has the ability to extend L, as one of its degrees of freedom.

1. I claim, a trimming and cutting device comprising: a plurality of robotic arms having varied precision and size affixed to each other; a wheeled movable device affixed to the bottom of the largest and least precise robotic arm; a cutting or trimming tool further mounted to the smallest most precise robotic arm.

2. I claim, a plurality of robotic arms as in claim 1, wherein said arms each have two or more degrees of freedom.

3. I claim, a plurality of robotic arms as in claim 1, wherein said degree of freedom if motorized is electric or hydraulic powered.

4. I claim, a most precise robotic arm as in claim 1, wherein said most precise robotic arm will be maneuvered by wireless remote control.

5. I claim, a cutting or trimming tool as in claim 1, wherein said cutting or trimming tool is electric powered.
